(19) United States
(12) Patent Application Publication
(10) Pub. No.: US 2010/0320959 A1
(43) Pub. Date: Dec. 23, 2010

(54) EXPANDED RANGE ELECTRIC VEHICLE WITH OFF-GRID BATTERY CHARGER

(76) Inventors: Michael D. Tomberlin, Augusta, GA (US); Frank Andrew Johnson, Appling, GA (US)

Correspondence Address: MEHRMAN LAW OFFICE, P.C., P.O. Box 420797, ATLANTA, GA, 30342, US

(21) Appl. No.: 12/822,095

(22) Filed: Jun. 23, 2010

Related U.S. Application Data
(60) Provisional application No. 61/219,636, filed on Jun. 23, 2009.

(51) Int. Cl. H01M 10/46; H02J 7/00

(52) U.S. Cl. 320/101; 320/109; 180/65.21

(57) ABSTRACT

A low speed electric vehicle (LSV) with an off-grid battery charger to extend the range of the vehicle including an internal combustion battery charging generator carried in the trunk space of the vehicle and an optional solar panel mounted on the roof of the vehicle. The internal combustion battery charging generator is distinguished from a conventional hybrid vehicle engine in that the battery charging generator is not mechanically connected to the vehicle drive train, but is instead only electrically connected to the traction battery as a battery charger. The internal combustion battery charging generator is provides sufficient battery charging energy to keep the batteries functionally charged during normal vehicle operation so that contents of a full gas tank and a fully charged battery bank can be consumed during continuous operation of the vehicle.

### REFERENCE TO RELATED APPLICATION

This application claim priority to U.S. Provisional Patent Application Ser. No. 61/219,636 filed Jun. 23, 2009, which in incorporated herein by reference.

### FIELD OF THE INVENTION

The present invention relates to low speed electric vehicles (LSVs) and, more particularly, relates to an extended range electric vehicle with an off-grid battery charger, such as a small gasoline, diesel or natural gas internal combustion electric generator carried onboard the vehicle for charging the vehicle's traction battery and providing accessory power.

### BACKGROUND OF THE INVENTION

Each year over 150,000 electric golf carts are leased to golf courses in the United States. These leases are typically for four years. When a golf course renews its fleet of cars, the old cars are typically sold to individuals for private use in gated communities, private property and driven around town. The result is that over 150,000 used and new electric golf cars enter into the marketplace each year. The market is also growing in the low speed vehicle (LSV) segment where the same types of vehicles are converted to street legal status under Federal Motor Vehicle Safety Standards.

One of the biggest concerns of the private owner of an electric golf cart or street legal LSV is the vehicle range. Typical golf carts and LSVs have a range of around 30 miles. As closed communities, neighborhoods, and localities grow and accept these vehicles, range becomes an even greater concern for customers. Ultimately, the range, time to recharge the batteries, and need to return to a home location to recharge the traction battery, and the potential for getting stranded when the batteries run out of charge away from home, are among the most important factors limiting the usefulness of electric vehicles for general local transportation.

The traction batteries in electric vehicles are typically recharged by plugging the vehicle into the electric power grid by way of a power converter or charging unit. Recharging the traction battery requires that the vehicle remain stationary and plugged into a power outlet, usually for a period of hours. Although some LSVs carry standard onboard battery chargers, most golf carts and many LSVs use charging units that are not carried onboard the vehicles, which means that the charging units are usually left at home locations. As a result, the need to recharge the traction battery interrupts the use of the vehicle, requires that it be returned to a home location for recharging, and limits the useful range of the vehicle.

### SUMMARY OF THE INVENTION

The present invention meets the needs described above in an extended range electric motor vehicle or low speed vehicle (LSV) having a drive train and a traction battery for powering the drive train to propel the vehicle. The LSV also includes an off-grid battery charger carried by the vehicle for charging the traction battery with electric power generated onboard the vehicle from a fuel supply carried onboard the vehicle. To distinguish the present invention from conventional hybrid vehicles, the off-grid battery charger is electrically connected to the traction battery and not mechanically connected to vehicle drive train. The off-grid battery charger preferably includes an internal combustion electric generator having a capacity sufficient to charge the traction battery “on the fly” by providing sufficient battery charging energy to keep the batteries functionally charged during normal vehicle operation so that contents of a full gas tank and a fully charged traction battery can be consumed during continuous operation of the vehicle.

In an illustrative embodiment, the off-grid battery charger is configured as a drop-in unit that includes a portion of the off-grid battery charger disposed as a self-contained portable unit configured for convenient attachment to and removal from the vehicle. The vehicle includes a mounting location, typically in the trunk space, configured to receive and attach the drop-in unit to the vehicle and a plurality of pre-installed components of the off-grid battery charger located within the vehicle. The vehicle also includes a drop-in unit receptacle located on the vehicle and pre-wired to the pre-installed components of the off-grid battery charger located within the vehicle. A power cable extending from the drop-in unit has a plug for connection to the drop-in unit receptacle for integrating the drop-in unit with the pre-installed components to create an operational internal combustion battery charging generator carried by the vehicle.

The off-grid battery charger includes an internal combustion electric generator and may include an optional a roof-mounted solar panel. The roof-mounted solar panel and the internal combustion electric generator may provide electric power to the charge the traction battery via a common battery charger. In addition, the off-grid battery charger may incorporate a standard onboard battery charger that can alternatively be used charge the traction battery from a conventional grid power supply. For operational convenience, the vehicle typically includes a gravity fed fuel tank having a filling port and a flip-open door trough the vehicle body (e.g., trunk lid) for accessing the filling port.

The vehicle may also include a remote starter for starting the internal combustion engine from an operator's seating position in the passenger compartment of the vehicle and an automatic engine shut-off system utilizing a voltage level detector for shutting off the internal combustion engine in response to detection of a traction battery voltage level above a threshold value. The vehicle may also include an automatic remote starting system utilizing the voltage level detector for starting the internal combustion engine in response to detection of a traction battery voltage level below a threshold value.

The vehicle may include a first power distribution circuit providing electric power to a pair of standard onboard battery chargers electrically connected to charge the traction battery. The vehicle may further include a second power distribution circuit delivering sufficient electric power to charge the traction battery onboard a second electric vehicle via a standard onboard battery charger onboard the second vehicle by plugging the battery charger onboard the second vehicle into the accessory panel onboard the first vehicle.

In another alternative, the vehicle includes a first power distribution circuit for charging the traction battery with power generated by the internal combustion electric generator and the roof-mounted solar panel, along with a second power distribution circuit supplying electric power generated by the internal combustion electric generator to an accessory panel. The second power distribution circuit may also include a switch for selectively providing electric power from the internal combustion electric generator to the traction battery via the vehicle's standard onboard battery charger.

The vehicle may also include a generator control panel having an electric start controller, an electric choke controller, and automatic start on/off controller. The generator control panel may also include a supplemental charger on/off controller operable for selectively connecting the standard onboard battery charger to an internal combustion electric generator. The generator control panel may also include a liquid fuel level indicator.

The vehicle may also include an exhaust system that includes an exhaust pipe, a muffler, and a tail pipe configured to quiet the generator exhaust and deliver exhaust gasses away from the passenger compartment of the vehicle. A cooling system typically includes one or more electric fans configured to blow cooling air across the engine of the internal combustion electric generator. In addition, a vibration mitigation system that includes a number of bushings mitigates vibration of an engine of the internal combustion electric generator.

### BRIEF DESCRIPTION OF THE DRAWINGS

FIG. 1 is a conceptual illustration of an extended range electric vehicle with an off-grid battery recharging system including an internal combustion battery charging generator and a roof mounted solar panel.

FIG. 2 is a functional block diagram of the extended range electric vehicle.

FIG. 3 is a functional block diagram of the internal combustion battery charging generator of the extended range electric vehicle.

FIG. 4 is a conceptual illustration of the fuel tank of the extended range electric vehicle.

FIG. 5 is a functional block diagram of the remote starter system of the extended range electric vehicle.

FIG. 6 is a functional block diagram of a first alternative power distribution system of the extended range electric vehicle.

FIG. 7 is a functional block diagram of a second alternative power distribution system of the extended range electric vehicle.

FIG. 8 is a conceptual illustration of the generator control system of the extended range electric vehicle.

FIG. 9 is a conceptual illustration of the exhaust system of the extended range electric vehicle.

FIG. 10 is a conceptual illustration of the cooling system of the extended range electric vehicle.

FIG. 11 is a conceptual illustration of the vibration mitigation system of the extended range electric vehicle.

FIG. 12 is a conceptual illustration of an extended range electric vehicle configured to receive a drop-in internal combustion electric generator.

### DETAILED DESCRIPTION

The present invention uses an off-grid battery charger to extend the range of low speed electric vehicles (LSVs) and thereby resolves the concern that many people may have with the potential for getting stranded when the traction batteries run down. The off-grid battery charger includes an internal combustion battery charging generator carried in the trunk space of the vehicle and an optional solar panel mounted on the roof of the vehicle. The internal combustion battery charging generator is distinguished from a conventional hybrid vehicle engine in that the battery charging generator is not mechanically connected to the vehicle drive train, but is instead only electrically connected to the traction battery as a battery charger. The internal combustion battery charging generator is preferably designed to provide sufficient battery charging energy to keep the batteries functionally charged during normal vehicle operation so that contents of a full gas tank and a fully charged traction battery can be consumed during continuous operation of the vehicle.

The electric generator of the extended range LSV incorporates a number of design features to customize the unit to make it suitable for the LSV application. The internal combustion battery charging generator includes a gravity fed gas tank with a refilling port accessible through a flip-open door. The generator also includes a remote starter and an automatic remote start capability that turns on the generator automatically when a low battery condition is detected. The power distribution system of the vehicle may incorporate the internal combustion battery charger and the roof-mounted solar panel while also providing accessory power sufficient to charge the batteries of a second LSV. The extended range LSV also includes custom exhaust, cooling and vibration mitigation systems.

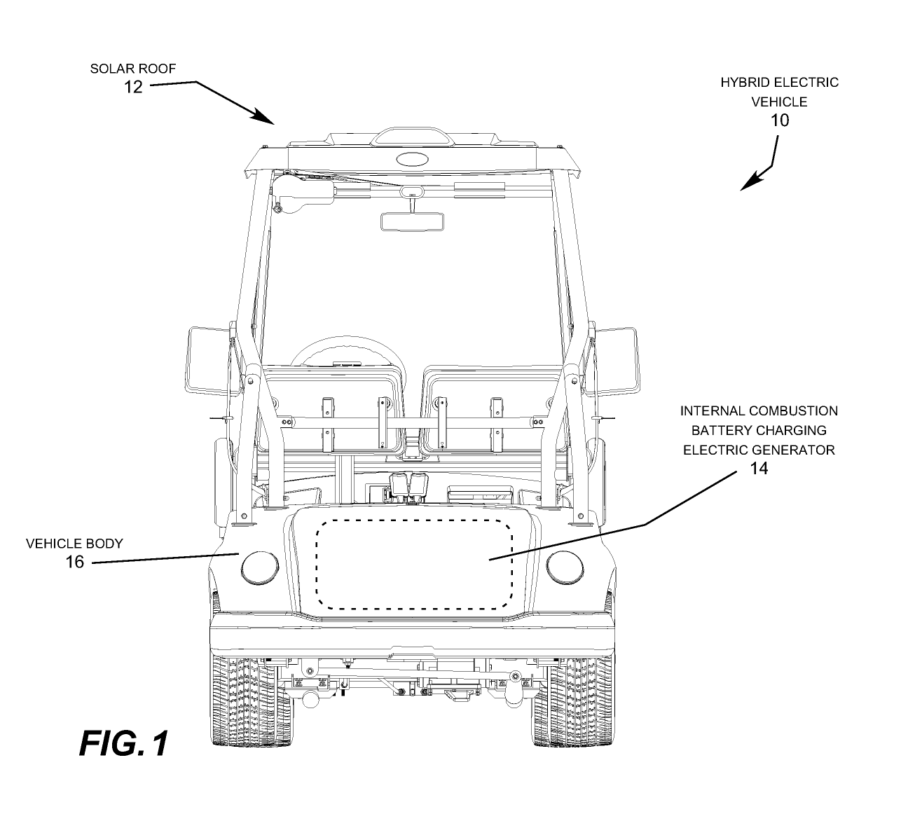

Turning now to the figures, FIG. 1 is a conceptual illustration of an extended range LSV 10 with an off-grid battery recharging system including an optional roof mounted solar panel 12 and an internal combustion battery charging generator 14 that is substantially concealed under the vehicle body 16. The generator 14 is located mainly in the trunk space of the vehicle, although certain components, such as the control panel, battery charging controllers, cooling fans, and other components may be mounted in other locations typically concealed by the vehicle body.

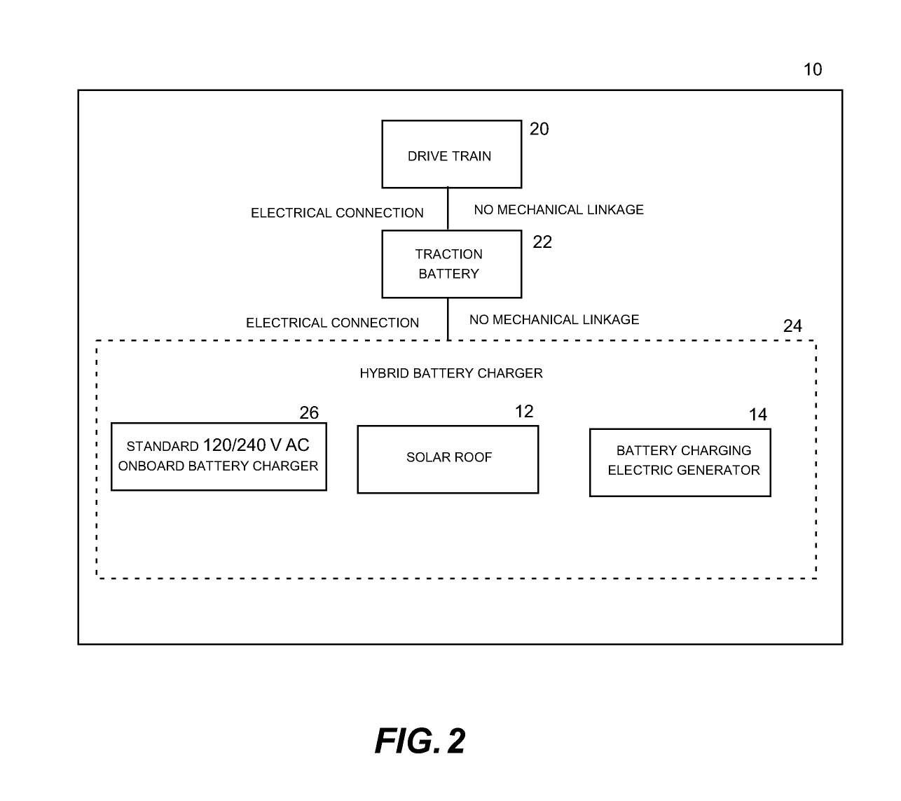

FIG. 2 is a functional block diagram of the components of the extended range LSV 10 pertinent to the present invention. The vehicle includes a drive train 20 powered by a traction battery 22 in which there is an electrical connection but no mechanical linkage between the drive train and the traction battery. A hybrid battery charger 26 is provided to charge the traction battery 22 and, again, there is an electrical connection but no mechanical linkage between the hybrid battery charger and the traction battery. The hybrid battery charger 26 allows the traction battery 22 to recharged from a standard on-board battery charger 26, the roof-mounted solar panel 12, and the internal combustion battery charging generator 14. The traction battery can preferably be recharged using all three sources simultaneously to increase the rate at which the traction battery is recharged.

It should be noted that the traction battery 22 is usually a multi-unit battery and may have a variety of designs. At present, lead-acid wet cell batteries are preferred for golf carts and LSVs due to their tolerance for deep discharging. Golf carts and LSVs typically come in a range of voltages, such as 36V, 48V, and 72V, whereas individual batteries are presently available in 12V, 8V and 6V options. Therefore, an electric vehicle typically carries a number of batteries connected in serried to provide the desired voltage for powering the electric motor. For example, a 36V LSV may carry 3 12V batteries or 6 6V batteries; a 48V LSV may carry 4 12V batteries, 6 8V batteries, or 8 6V batteries; and so forth. It should be appreciated that dry cell, lithium and other types of batteries are now or will in the future become available for this application. The present invention is independent of the specific type, voltage and battery configuration of the electric vehicle.

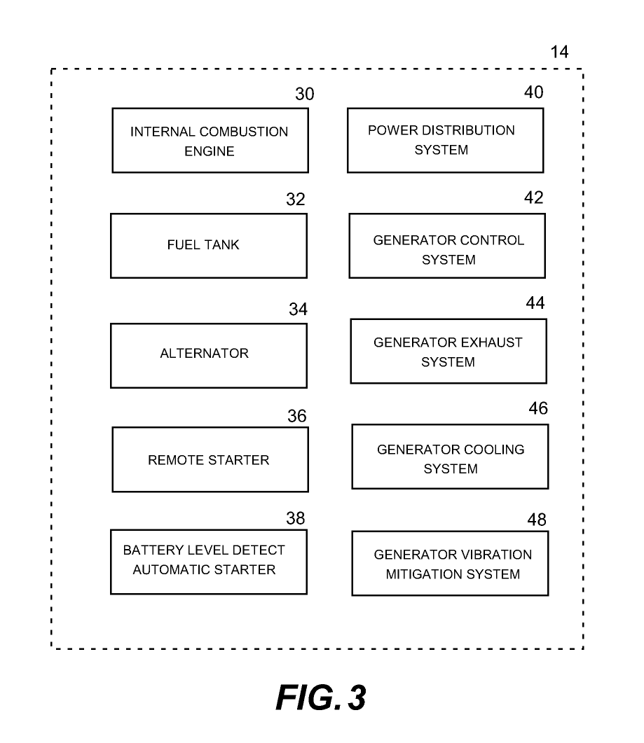

FIG. 3 is a functional block diagram of the internal combustion battery charging generator 14 of the extended range electric vehicle. The generator includes the following components pertinent to the present invention: an internal combustion engine 30, a fuel tank 32, an alternator 34, a remote starter 36, a battery level detector and automatic remote starter 38, a power distribution system 40, a generator control system 42, a generator exhaust system 44, a generator cooling system 46, and a vibration mitigation system 48. Each of these components is described in greater detail with reference to a following figure.

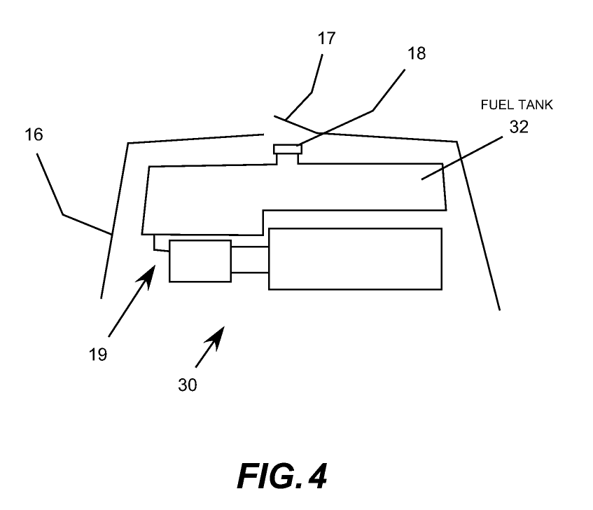

FIG. 4 is a conceptual illustration of the fuel tank 32 of the extended range electric vehicle, which in this example is gasoline powered. The fuel tank 32 is located above the engine and under the vehicle body 16, preferably in the trunk space immediately below the trunk lid. A flip-open door 17 through the trunk lid provides access to a cap 18 that can be removed from the fuel tank for filling the tank with gasoline. The fuel tank 32 is typically located directly above the internal combustion engine 30 so that the fuel is delivered to the engine through a short conduit 19. The fuel tank is preferably configured with a “saddle” shape to maximize the capacity of the tank within the available space while taking other considerations, such as cooling air flow, into account. Of course, the fuel tank can be located elsewhere and a fuel pump can be used to deliver the gasoline from the fuel tank to the engine if desired.

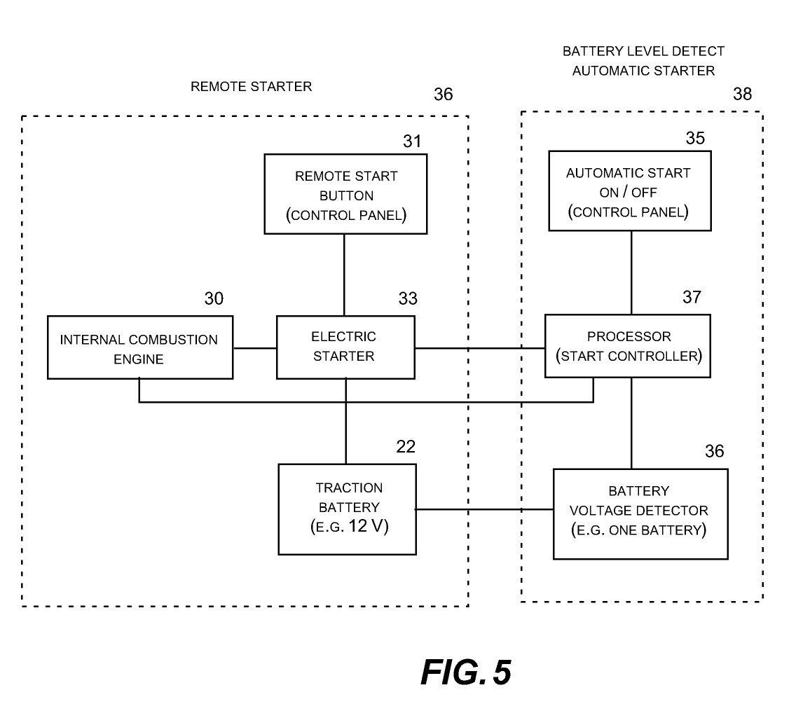

FIG. 5 is a functional block diagram of the remote starter system 36 and the automatic starter system 38 of the extended range electric vehicle 10. The starter system 36 consists of a remote start button 31, which is typically located on a generator control panel operable from the vehicle operator's seating position in the passenger compartment of the vehicle. The generator control panel, including the remote starter, may be located on the forward facing battery cabinet wall under the front seats of the vehicle. The generator control panel may alternatively be located in other convenient locations, such as on the dash board, steering column, steering wheel, heads-up display, or other suitable location. The elements of the generator control panel may also be distributed in various locations on the vehicle, if desired.

The remote start button 31 activates an electric starter 33 that starts the engine 30 in the usual way. The electric starter is preferably powered from a portion of the traction battery bank 22. For example, the electric starter typically requires 12V whereas the electric vehicle may have a 48V drive system. In this case, the electric starter may be connected across two 6V batteries of the traction battery bank to provide the desired 12V power source to the starter. This avoids the need for an additional 12V battery for the electric starter.

The electric vehicle further includes an automatic remote start capability, which includes an automatic start on/off switch 35 typically located on the generator control panel, a processor 37, and a battery voltage detector 36, which indicates the charge level of the traction battery 22. When the on/off switch 35 is in the “on” position, the processor 37 automatically activates the electric starter 33 when the battery voltage falls below a partially discharged threshold level to charge the traction battery 22. The processor 37 also turns off the internal combustion engine 30 automatically to discontinue charging the traction battery 22 when the battery voltage reaches a fully-charged threshold level.

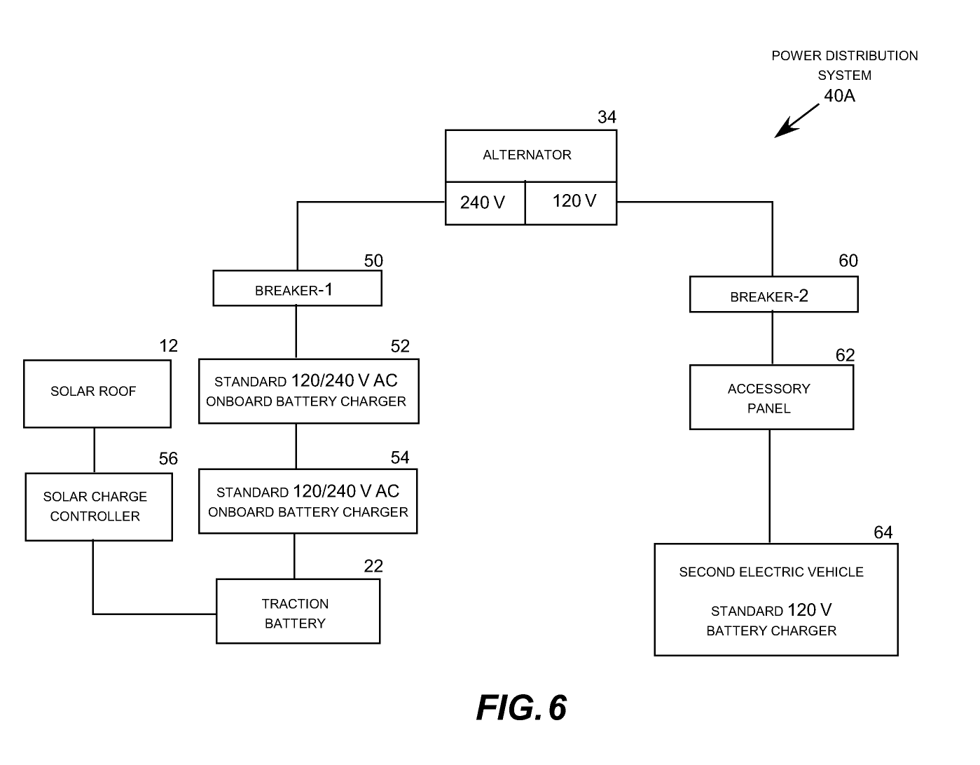

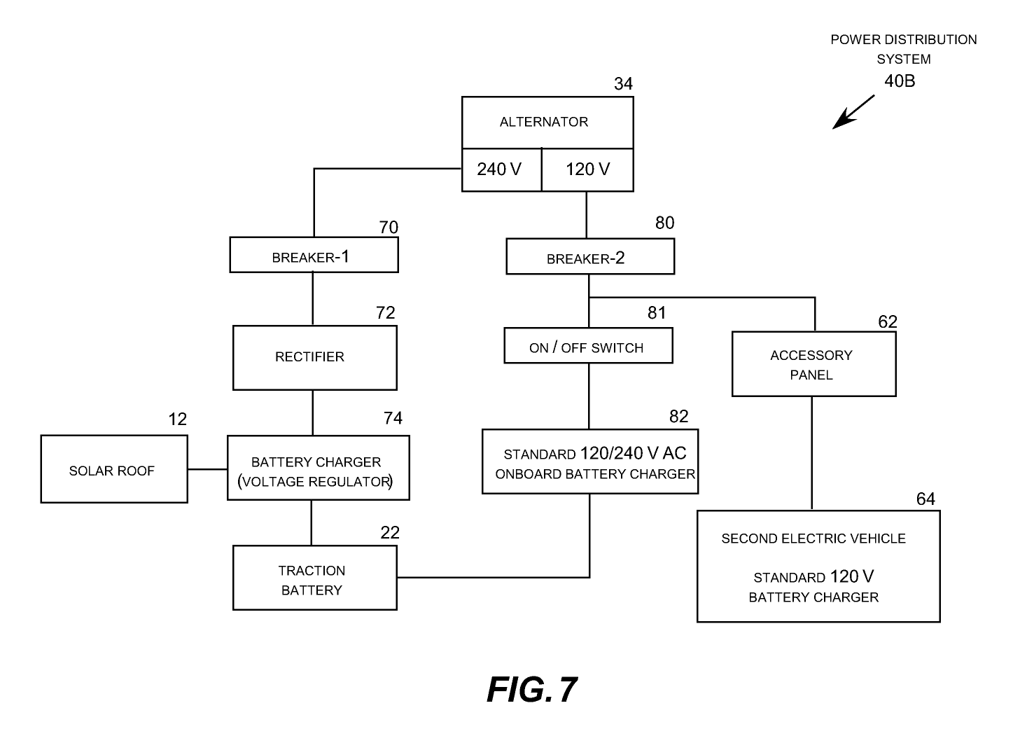

FIGS. 6 and 7 are functional block diagrams of example power distribution systems for the extended range electric vehicle. While these configurations are illustrative they are by no means exclusive. Once the principles of the invention are appreciated from these examples, other electrical distribution configurations may be implemented as a mater of design choice. FIG. 6 is a functional block diagram of a first alternative for a power distribution system 40A. In this circuit, the generator includes an alternator 34 with 240V AC and 120V AC outputs available. The 240V AC output feeds a first circuit controlled by a first circuit breaker 50, which typically limits the current in the circuit to the range of 20 to 30 Amps. In this configuration, the 240V circuit provides power to two standard onboard 120/240V AC battery chargers 52 and 54, which are connected in parallel to receive 240V AC. As both batteries are connected across 240V AC, they will charge the traction battery at approximately four times the rate achieved by a single standard battery charger connected to a 120V AC grid power supply. In this alternative, the roof-mounted solar panel 12 is connected to charge the traction battery 22 through a separate solar charge controller 56.

The 120V AC alternator output feeds a second circuit breaker 60, which provides power to an accessory panel 62 containing a number, typically two or four, standard 120V AC power receptacles. 12V DC and other accessory power ports may be provided, as desired. The second circuit breaker 60 also limits the current in circuit to the range of 20 to 30 Amps, which is sufficient to charge the batteries in another electric vehicle by plugging the onboard battery charger into a receptacle on the accessory panel of the first electric vehicle. The 120V AC circuit also provide sufficient power to run additional accessories, such as computer and mobile phone chargers, radio, television, lights, and other desired accessories.

FIG. 7 is a functional block diagram of a second alternative power distribution system 40B for the extended range electric vehicle. This alternative has the advantage of eliminating the need for a second standard onboard battery charger and a separate solar charge controller. In this alternative, the 240V AC output from the alternator 34 feeds a first breaker 70, which provides power to a rectifier 74 and a battery charger (voltage regulator) 76, which charges the traction battery 22. For example, a “flexcharge” type battery charger is suitable for this application. The first circuit breaker 70 typically limits the current in the circuit to the range of 20 to 30 Amps. The battery charger 76 also receives DC power from the roof mounted solar panel 12, which typically adds another 2 to 3 Amps, and provides this power to the traction battery 22 in addition to power from the alternator 34.

The power distribution system 40B also includes a second breaker 80 connected to the 120V AC alternator output, which may be selectively connected via the on/off switch 81 to the standard onboard battery charger 82 to provide a supplemental power source of battery charging power. As a result, the 240V AC battery charger 74, the standard onboard battery charger 82, and the solar panel 12 may all be connected simultaneously to charge the traction battery 22.

The second breaker 80 also provides power to the accessory panel 62 containing the standard 120V AC power receptacles. Again, the second breaker 80 typically limits the current in circuit to the range of 20 to 30 Amps, which is sufficient to charge the batteries in another electric vehicle by plugging the onboard battery charger into a receptacle on the accessory panel of the first electric vehicle. The 120V AC circuit also provides sufficient power to run additional accessories, such as computer and mobile phone chargers, radio, television, lights, and other desired accessories.

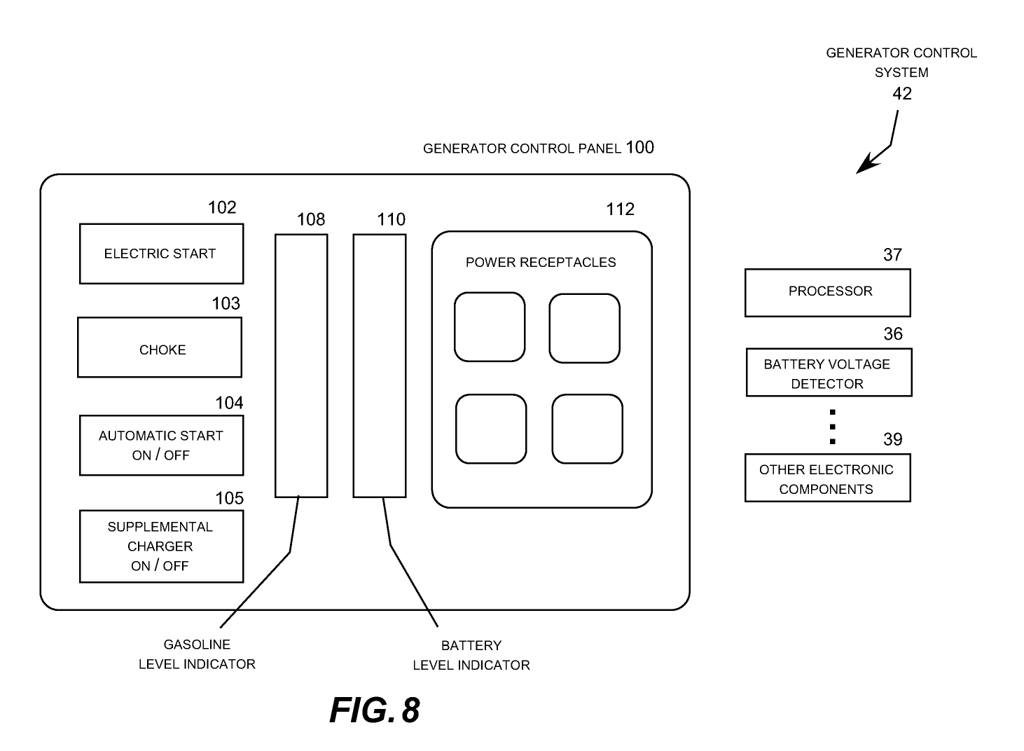

FIG. 8 is a conceptual illustration of the generator control system 42 of the extended range electric vehicle 10. The control system typically includes a generator control panel 100 mounted in a convenient location (or distributed in several locations, if preferred) along with the processor 37, the battery voltage detector 36, and other electrical components represented by the component 39 located in convenient locations within the vehicle. The generator control panel 100 typically includes a remote start button 102, an electric choke control 103, an automatic start on/off switch 104, and a supplemental battery charger on/off switch 105. The supplemental battery charger on/off switch 105 allows the operator to control whether the standard onboard battery charger is energized by the generator as a supplemental battery charger. The operator may want to turn this feature off, for example, to avoid wear on the standard onboard battery charger or to free up available generator capacity to power accessories or charge another electric vehicle via the generator.

The generator control panel 100 may also include a gasoline level indicator 108, a traction battery level charge level indicator 110, and a number of power receptacles 112. Other power outputs, switches and indicators may be provided as desired. For example, the generator control panel 100 may include indicators showing the power produced by the roof-mounted solar roof 12, the battery charging current, the current in various circuits, and so forth.

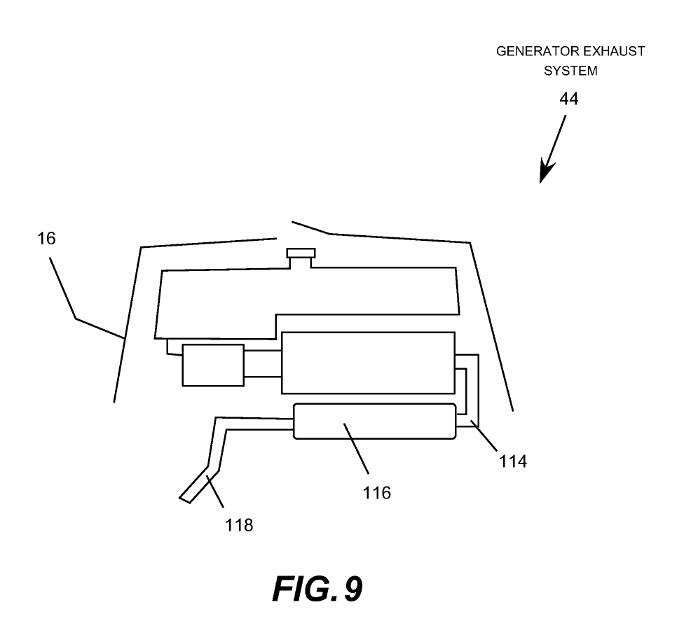

FIG. 9 is a conceptual illustration of an exhaust system 44 for the extended range electric vehicle 10. The exhaust system 44, which typically includes an exhaust pipe 114, a muffler 116, and a tail pipe 118, is designed to quiet the exhaust and route the exhaust gasses out from under the vehicle body 16 and away from the passenger compartment of the vehicle.

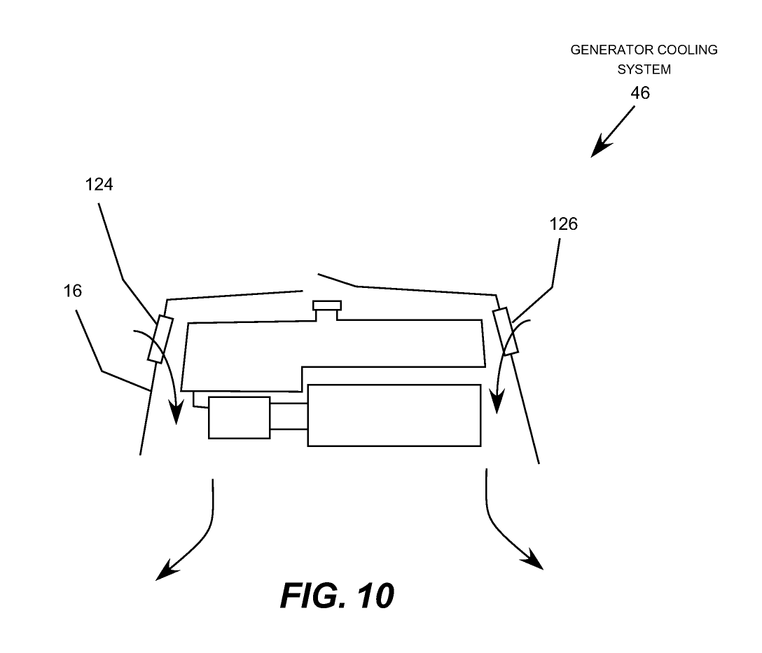

FIG. 10 is a conceptual illustration of a cooling system 46 for the extended range LSV 10. The exhaust system 46 includes vents or electric fans 124 and 126 to direct a flow of air around the engine and under the vehicle body 16 to crate a cooling air flow for the engine. Vents or fans may also be included to direct cooling air across electrical components, such as the battery chargers and rectifiers.

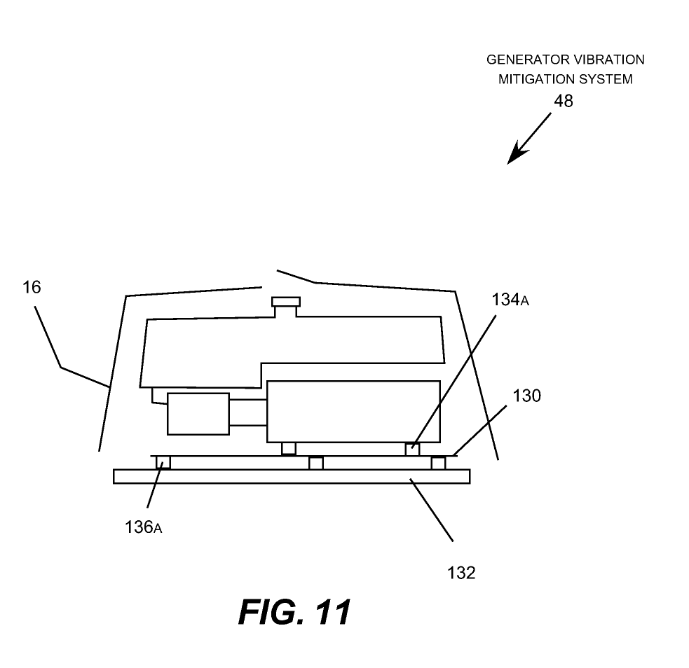

FIG. 11 is a conceptual illustration of the vibration mitigation system 48 for the extended range electric vehicle 10. In general, the engine is supported by a mounting plate 130 that is supported by the vehicle frame 132. A number of shock absorbers represented by the shock absorbers 134A connect the engine to the support plate 130 and an additional number of shock absorbers represented by the shock absorber 136A connect the support plate 130 to the frame 132. For example, the shock absorbers may be rubber bushings or other types of cushions, air bladders, springs, or other suitable types of shock absorbers. Additional shock absorbers may be provided as desired.

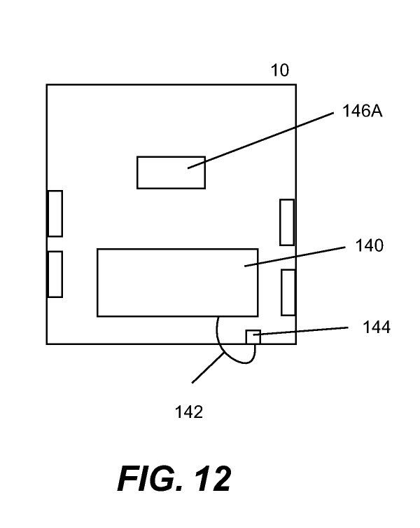

FIG. 12 is a conceptual illustration of an extended range electric vehicle 10 configured to receive a drop-in internal combustion electric generator 140. In this alternative, most of the components of the internal combustion electric generator are provided in the drop-in unit 140, which is configured to be conveniently installed in the trunk space of a standard electric vehicle. The drop-in unit 140 is connected via a cable 142 to a port in the electric vehicle, which, in turn, is pre-wired and provisioned with a number of pre-installed components represented by the pre-installed component 146A. The preinstalled components typically include the generator control panel and the elements of the power distribution and cooling systems.

The invention claimed is:

1. An extended range electric motor vehicle, comprising:
a drive train;
a traction battery for powering the drive train to propel the vehicle;
an off-grid battery charger carried by the vehicle configured to charge the traction battery with electric power generated onboard the vehicle from a fuel supply carried onboard the vehicle; and
wherein the off-grid battery charger is electrically connected to the traction battery and not mechanically connected to vehicle drive train.

2. The extended range electric motor vehicle of claim 1, wherein the off-grid battery charger comprises an internal combustion electric generator configured to provide sufficient battery charging energy to keep the traction battery functionally charged during normal vehicle operation to cause a full tank of fuel supplying the internal combustion engine and electric energy stored within the traction battery in a fully charged condition to be consumed during continuous operation of the vehicle of sufficient duration.

3. The extended range electric motor vehicle of claim 1, wherein the off-grid battery charger comprises:
a drop-in unit comprising a portion the off-grid battery charger disposed as a self-contained portable unit configured for convenient attachment to and removal from the vehicle;
a mounting location on the vehicle configured to receive and attach the drop-in unit to the vehicle;
a plurality of pre-installed components of the off-grid battery charger located within the vehicle;
a drop-in unit receptacle located on the vehicle pre-wired to the pre-installed components of the off-grid battery charger located within the vehicle; and
a power cable extending from the drop-in unit having a plug configured for connection to the drop-in unit receptacle for integrating the drop-in unit with the pre-installed components to create an operational internal combustion battery charging generator carried by the vehicle.

4. The extended range electric motor vehicle of claim 1, wherein the off-grid battery charger comprises a roof-mounted solar panel and an internal combustion electric generator:

5. The extended range electric motor vehicle of claim 4, wherein the roof-mounted solar panel and the internal combustion electric generator provide electric power to the charge the traction battery via a common battery charger.

6. The extended range electric motor vehicle of claim 1, wherein the off-grid battery charger comprises a standard onboard battery charger configured to selectively charge the traction battery from a grid power supply.

7. The extended range electric motor vehicle of claim 1, further comprising a remote starter for starting an internal combustion engine of the off-grid battery charger operable from an operator's seating position in a passenger compartment of the vehicle.

8. The extended range electric motor vehicle of claim 1, further comprising an automatic engine shut-off system comprising a voltage level detector operable for shutting off an internal combustion engine of the off-grid battery charger in response to detection of a voltage level of the traction battery above a threshold value.

9. The extended range electric motor vehicle of claim 1, further comprising an automatic remote starting system comprising a voltage level detector operable for starting an internal combustion engine of the off-grid battery charger in response to detection of a voltage level of the traction battery below a threshold value.

10. The extended range electric motor vehicle of claim 1, further comprising a gravity fed fuel tank having a filling port and a flip-open door trough a body of the vehicle for accessing the filling port.

11. The extended range electric motor vehicle of claim 1, wherein the vehicle is a first vehicle, further comprising:
a first power distribution circuit onboard the first vehicle providing electric power to a pair of standard onboard battery chargers electrically connected to charge the traction battery onboard the first vehicle with electric power generated by an internal combustion engine of the off-grid battery charger onboard the first vehicle;
a second power distribution circuit onboard the first vehicle providing electric power to an accessory panel carried by the first vehicle;
wherein the second power distribution circuit is configured to deliver sufficient electric power to charge a traction battery onboard a second electric vehicle via a standard onboard battery charger onboard the second vehicle by plugging the battery charger onboard the second vehicle into the accessory panel onboard the first vehicle.

12. The extended range electric motor vehicle of claim 1, further comprising a roof-mounted solar panel and a solar battery charger electrically connecting the solar panel to the traction battery.

13. The extended range electric motor vehicle of claim 1, further comprising:
a first power distribution circuit configured to charge the traction battery with power generated by an internal combustion electric generator and a roof-mounted solar panel; and
a second power distribution circuit supplying electric power generated by the internal combustion electric generator to an accessory panel.

14. The extended range electric motor vehicle of claim 13, wherein the second power distribution circuit further comprises a switch for selectively providing electric power from the internal combustion electric generator to the traction battery via a standard onboard battery charger.

15. The extended range electric motor vehicle of claim 1, further comprising a generator control panel comprising an electric start controller, an electric choke controller, and automatic start on/off controller.

16. The extended range electric motor vehicle of claim 15, wherein the generator control panel further comprises a supplemental charger on/off controller operable for selectively connecting a standard onboard battery charger to an internal combustion electric generator of the off-grid battery charger.

17. The extended range electric motor vehicle of claim 15, wherein the generator control panel further comprises a liquid fuel level indicator.

18. The extended range electric motor vehicle of claim 1, wherein the off-grid battery charger comprises an internal combustion electric generator, further comprising an exhaust system comprising an exhaust pipe, a muffler, and a tail pipe configured to quiet the generator exhaust and deliver exhaust gasses away from a body of the vehicle.

19. The extended range electric motor vehicle of claim 1, wherein the off-grid battery charger comprises an internal combustion electric generator, further comprising one or more electric fans configured to blow cooling air across an engine of the internal combustion electric generator.

20. The extended range electric motor vehicle of claim 1, wherein the off-grid battery charger comprises an internal combustion electric generator, further comprising a vibration mitigation system comprising a plurality of bushings configured to mitigate vibration of an engine of the internal combustion electric generator.
